(19) United States
(12) Patent Application Publication
(10) Pub. No.: US 2014/0080582 A1
(43) Pub. Date: Mar. 20, 2014

(54) GAMING APPARATUS AND METHOD OF GAMING

(71) Applicant: Dynamite Services Pty Ltd, Neutral Bay (AU)

(72) Inventor: Benjamin James Ellis, Sydney (AU)

(73) Assignee: Dynamite Services Pty Ltd, Neutral Bay (AU)

(21) Appl. No.: 14/026,333

(22) Filed: Sep. 13, 2013

(30) Foreign Application Priority Data
Sep. 19, 2012 (AU) 2012227189

(51) Int. Cl. G07F 17/32

(52) U.S. Cl. CPC G07F 17/32
USPC 463/25

(57) ABSTRACT

A method of gaming comprises: displaying play of a wager game; triggering a first feature of the wager game in which one or more feature enhancing elements are awardable to a player; randomly triggering a second feature of the wager game during play of the wager game and/or first feature; and utilising awarded feature enhancing elements in the second feature to improve a prize potential for the second feature.

### FIELD OF THE INVENTION

The present invention relates to gaming systems, game controllers and methods of gaming. It relates for example to electronic gaming machines and to networked gaming systems, such as Internet-based gaming systems.

### BACKGROUND OF THE INVENTION

Gaming machines have been a popular form of entertainment for many years. This popularity has been enhanced with the advent of electronic gaming machines and computer-based gaming systems, such as are provided over the Internet.

Many different types of game are playable on such gaming machines. They include for example standard slot-machine type games with spinning reels, poker machines, keno, bingo, blackjack, roulette, pachinko and the like.

A user will typically place a bet to begin a game, and will win or lose based upon the rules of the game.

While such games provide users with enjoyment, the need exists for alternative gaming systems in order to maintain or increase player enjoyment.

### SUMMARY OF THE INVENTION

According to a first aspect of the invention there is provided a method of gaming comprising:

displaying play of a wager game;

triggering a first feature of the wager game in which one or more feature enhancing elements are awardable to a player;

triggering a second feature of the wager game, the second feature being randomly triggerable during play of at least one of the wager game and the first feature; and

allowing awarded feature enhancing elements to be utilised in the second feature to provide a player advantage in the second feature.

In an embodiment the first feature comprises a set number of plays such that the feature enhancing elements are randomly awarded to the player during the set number of plays.

In an embodiment the first feature is a symbol driven game such that the feature enhancing elements are awarded in response to one or more predefined symbol combinations being triggered during the set number of plays.

In an embodiment the awarded feature enhancing elements are selectively utilised by the player, such that not all awarded feature enhancing elements are necessarily utilised in the second feature.

In an embodiment the method further comprises allowing the player to select a time or particular stage in the second feature at which to utilise the feature enhancing elements, such that the selected timing/stage has a bearing on the player advantage.

In an embodiment the feature enhancing elements are automatically utilised in the second feature.

In an embodiment the second feature comprises a symbol driven game and wherein the feature enhancing elements comprise special symbols that are added to a symbol set from which symbols are randomly drawn for improving a prize potential of the second feature.

In an embodiment the second feature comprises a symbol driven game and wherein the feature enhancing elements are operable to modify symbols in a symbol set utilised in the symbol driven game for improving a prize potential of the second feature.

In an embodiment the feature enhancing elements are operable to modify an outcome of the second feature for improving the prize potential.

In an embodiment the feature enhancing elements are operable to add, modify or improve a probability of triggering, a special feature of the second feature that provides an improved prize potential.

In an embodiment the feature enhancing elements can be applied to one or more game play parameters of the second feature.

In an embodiment the feature enhancing elements comprise virtual game characters, character abilities and/or objects that can be utilised to progress, or increase a likelihood of progressing through, one or more stages of the second feature for improving the prize potential.

In an embodiment different feature enhancing elements are awardable during play of the first feature such that certain awardable feature enhancing elements improve the prize potential more than other awardable feature enhancing elements.

In an embodiment play of the first feature does not result in any prizes being awarded to the player other than the feature enhancing elements.

In an embodiment the first feature is triggered in response to a wager place by the player.

In an embodiment the first feature is randomly triggered during play of the wager game.

In an embodiment the method further comprises allowing certain awarded feature enhancing elements to be utilised in the second feature only if other predefined feature enhancing elements have been awarded to the player.

In accordance with a second aspect of the present invention there is provided a gaming apparatus comprising:

a display module operable to display play of a wager game;

a feature module operable to trigger a first feature of the wager game in which one or more feature enhancing elements are awardable to a player, the feature module being further operable to randomly trigger a second feature during play of at least one of the wager game and first feature; and

an award module operable to allow feature enhancing elements awarded to the player prior to triggering of the second feature to be utilised in the second feature to improve a prize potential thereof.

In an embodiment the first feature comprises a set number of plays such that the feature enhancing elements are randomly awarded to the player during the set number of plays.

In an embodiment the first feature is a symbol driven game such that the feature enhancing elements are awarded in response to one or more predefined symbol combinations being triggered during the set number of plays.

In an embodiment the awarded feature enhancing elements are selectively utilised by the player, such that not all awarded feature enhancing elements are necessarily utilised in the second feature.

In an embodiment the award module is operable to allow the player to select a time or particular stage in the second feature at which to utilise the feature enhancing elements, such that the selected timing has a bearing on the amount by which the prize potential is improved.

In an embodiment the feature enhancing elements are automatically utilised by the award module in the second feature.

In an embodiment the second feature comprises a symbol driven game and wherein the feature enhancing elements comprise special symbols that are added to a symbol set from which symbols are randomly drawn for improving the prize potential of the second feature.

In an embodiment the second feature comprises a symbol driven game and wherein the feature enhancing elements are operable to modify symbols in a symbol set utilised in the symbol driven game for improving the prize potential.

In an embodiment the feature enhancing elements are operable to modify an outcome of the second feature for improving the prize potential.

In an embodiment the feature enhancing elements are operable to add, modify or improve a probability of triggering, a special feature of the second feature for improving the prize potential.

In an embodiment the feature enhancing elements can be applied to one or more game play parameters of the second feature.

In an embodiment the feature enhancing elements comprise virtual game characters, character abilities and/or objects that can be utilised to progress, or increase a likelihood of progressing through, one or more stages of the second feature.

In an embodiment different feature enhancing elements are awardable during play of the first feature such that certain awardable feature enhancing elements improve the prize potential more than other awardable feature enhancing elements.

In an embodiment play of the first feature does not result in any prizes being awarded to the player other than the feature enhancing elements.

In an embodiment the first feature is triggered by the feature module in response to a wager place by the player.

In an embodiment the first feature is randomly triggered by the feature module during play of the wager game.

In an embodiment the award module is operable to allow certain awarded feature enhancing elements to be utilised in the second feature only if other predefined feature enhancing elements have been awarded to the player.

In accordance with a third aspect of the present invention there is provided a gaming system comprising:

a gaming terminal implementing a display; and

a gaming controller comprising: a display module operable to display play of a wager game;

a feature module operable to trigger a first feature of the wager game in which one or more feature enhancing elements are awardable to a player, the feature module being further operable to randomly trigger a second feature during play of at least one of the wager game and first feature; and

an award module operable to allow feature enhancing elements awarded in the first feature to be utilised in the second feature to improve a prize potential for the second feature.

In accordance with a fourth aspect of the present invention there is provided a method of gaming comprising the steps of:

displaying play of a wager game;

conducting play of a first feature of the wager game in which one or more feature enhancing elements are randomly awardable to a player;

conducting play of a second feature of the wager game; and

allowing awarded feature enhancing elements to be utilised in the second feature to provide a player advantage in the second feature.

In an embodiment the elements are selectively utilised by the player.

In accordance with a fifth aspect of the present invention there is provided a method of gaming comprising the steps of:

displaying play of a wager game;

triggering a first feature of the wager game in which one or more feature enhancing elements are randomly awardable to a player; and

triggering a second feature of the wager game, such that the player is able to utilise awarded feature enhancing elements in the second feature to provide a player advantage therein;

wherein if no feature enhancing elements have been awarded to the player upon the second feature being triggered, the second feature is played without any player advantage.

In an embodiment, if no feature enhancing elements have been awarded to the player upon the second feature being triggered, the second feature is played at a default prize potential.

In accordance with a sixth aspect there is provided a computer program code which when executed by a computing system implements the method as described in accordance with any one of the aforementioned aspects.

In accordance with a seventh aspect there is provided a computer readable medium comprising the computer program code of the sixth aspect.

An embodiment of the system further includes a central control for running a gaming algorithm, and a plurality of remote clients in communication with the central control over a communications network, the remote clients including screens for the display of information to players.

Embodiments of the present invention may be applied to any suitable type of gaming system or platform. It can apply to stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers, PDAs, mobile telephones, digital televisions, and the like, e.g. over the Internet or other communications networks.

Embodiments may be applied to gaming apparatus that play any suitable game, but especially relate to slot-machine type games.

In some networked embodiments of the invention, the central control may conduct the games and manage the accounting and the like, and a number of remote terminals/clients merely provide the user input and display mechanisms. In other networked embodiments of the invention, the control of the games and various other features may be carried out at the remote terminals, or may be split between the central control and the remote terminals.

### BRIEF DESCRIPTION OF THE ACCOMPANYING DRAWINGS

Embodiments of the invention will hereafter be described, by way of example only, with reference to the accompanying drawings, in which:

FIG. 1 is a block diagram of gaming apparatus according to one embodiment of the present invention;

FIG. 2 is a schematic of a game controller according to an embodiment; and

FIGS. 3 and 4 are flow diagrams of a gaming control process in accordance with an embodiment of the present invention.

### DETAILED DESCRIPTION

In an embodiment a game controller of a gaming device comprises a display module operable to provide the display of a wager game having a triggerable first feature in which one or more feature enhancing elements are awardable to a player. Responsive to a second feature being triggered, one or more feature enhancing elements previously awarded to the player may be utilised for providing a player advantage therein. As used herein, the term “player advantage” generally refers to a mathematical likelihood of achieving a prize, and/or a magnitude of prize, that is superior to the probability of achieving a prize or one of a similar magnitude without the feature enhancing elements having been utilised. It will be understood that if no feature enhancing elements had been accumulated by the player prior to the triggering of the second feature, the second feature may be played without any player advantage (e.g. at some default prize potential, return to player percentage, etc.).

### General Construction of a Gaming System

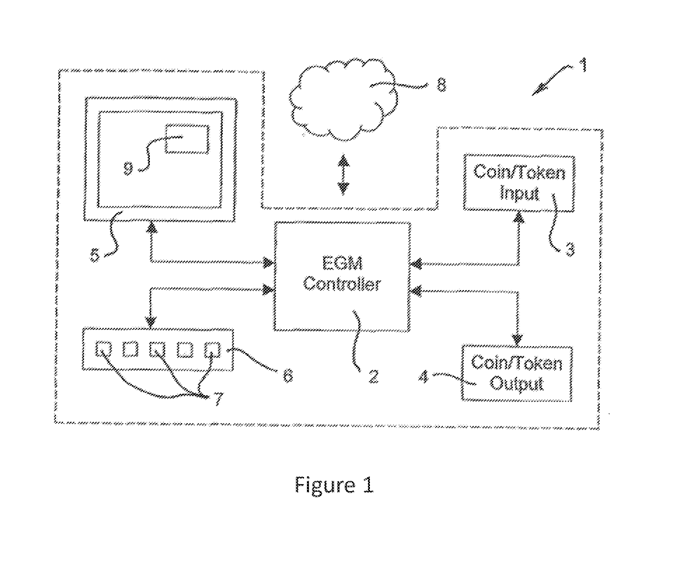

Referring to FIG. 1 there is shown a gaming apparatus, which in this case takes the form of an electronic gaming machine (EGM) 1, and which includes various standard components, such as a game controller 2 for controlling the operation of the EGM 1 and the games run on it, a note/coin/token input 3 for receiving bets, a note/coin/token output 4 for paying out winnings, one or more displays 5 for displaying game screens, and player input means 6 for allowing user interaction, which may include e.g. buttons 7 and which may e.g. be provided as part of the display 5 in a touch-screen type manner. The EGM 1 also includes a player tracking and marketing means 9 having a reading device (e.g. a card scanner for reading a smart card or other form of portable storage medium capable of being read by the card scanner) which communicates with a remote server for providing player tracking and loyalty type functions, as is well understood in the art. Additional hardware may be included as part of the EGM 1, or hardware may be omitted as required by the specific implementation.

In one form the EGM 1 may be a stand-alone machine. In another form, the EGM may be networked with other EGMs and/or a control centre via a suitable communications network 8, such as a LAN and/or WAN, in order to play networked (e.g. intranet or Internet) games, such as a linked jackpot. It will be appreciated that the EGM 1 may include an appropriate communications interface, such as a network card, for communicating over the communications network 8.

In use, the EGM 1 will display an initial gaming screen on the display 5. A player will insert bank notes, coins and/or tokens into the EGM input 3 (or may be credited with coins, credits or tokens), and will press a button 7 to initiate play of the main game provided by the EGM 1. How matters then proceed will depend on the type of main game being played. For example, a game screen from a slot machine-type game played on the EGM 1 may display virtual reels of symbols, with the reels being spun and stopped in various win and lose symbol combinations on one or more paylines, in accordance with a stored gaming algorithm and a random number generator. It will be understood that any suitable slot machine-type main game may be suitable for use with embodiments described herein. As used in this document, including in the claims, the terms “random”, “randomly”, “randomized”, and the like, are to be construed as connoting either a purely random process or a “pseudo-random” process. An example of a pseudo-random process includes the determination by a computer processor of a pseudo-random number in response to an output of a digital clock.

The player may interact via the buttons 7, so as e.g. to spin or hold reels and otherwise play the main game. A common element will be win events, e.g. particular symbol combinations that pay out a prize.

FIG. 1 illustrates an essentially stand-alone EGM (albeit with the potential for networked connectivity). However, in an alternative embodiment the system may be implemented over a distributed architecture where some of the individual EGM modules are implemented remotely. For example, in one particular form, a central control computer which is located remotely of the EGM may implement a controller which controls some or all of the game play functionality (i.e. such that the EGM essentially operates as a remote client arranged to provide audible and/or visual gaming information to a player and allow player interaction with the central control computer). A plurality of EGM clients may be in communication with the central control computer over a communications network such as a local area network and/or a wide area network. In an alternative embodiment, the game play functionality may be implemented by both the EGM and central control computer such that they collectively provide a game controller.

The central control computer has access to associated memory and storage devices. The central control computer also has access to computer executable code for instructing the central control computer to run the gaming algorithm that performs the embodiment of the inventive method. In one embodiment the computer executable code is in the form of software and associated data, which are stored upon a computer-readable medium in the form of one or more compact disks. Alternative embodiments make use of other forms of digital storage media, such as Digital Versatile Discs (DVD's), hard drives, flash memory, Erasable Programmable Read-Only Memory EPROM, and the like. Alternatively, the software and its associated data may be stored as one or more downloadable or remotely executable files that are accessible via a computer communications network such as the internet.

### Detail of the Game Controller

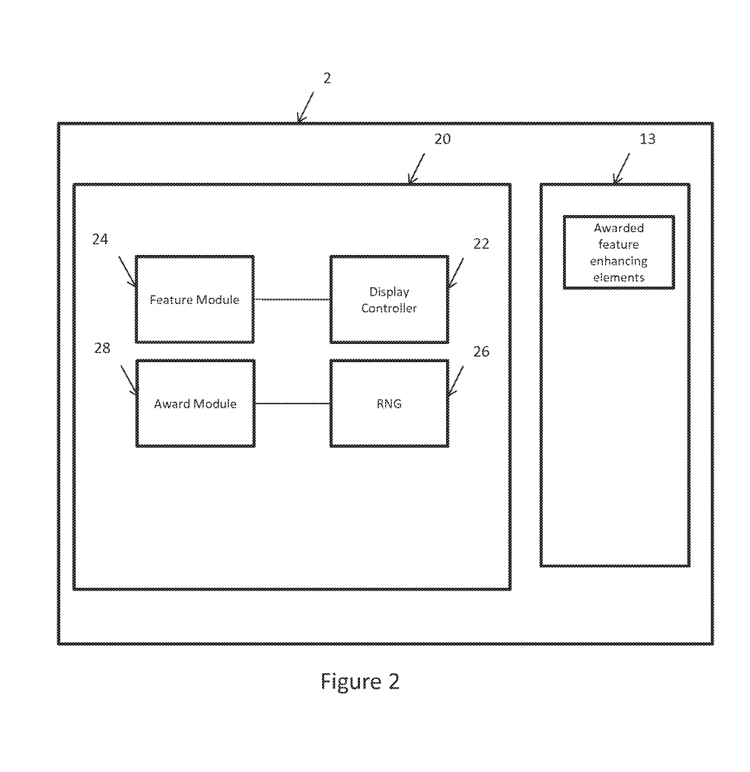

The game controller 2 of an embodiment is shown in more detail in FIG. 2. For simplicity only those modules (which may be implemented in hardware, software, or a combination of the two) needed to carry out embodiments are illustrated. Other standard and/or non-standard modules may also be implemented for carrying out operation of normal and feature game play functionality. It will be understood that the term “processor” as used herein is to be construed broadly and include within its scope any device that can process gaming algorithms and may include a microprocessor, microcontroller, programmable logic device or other computational device, a general purpose computer, or a server computer. Typically, the gaming algorithms (instructions) are stored as program code in memory 13, which is in data communication with the processor.

In the illustrated embodiment, the game controller 2 includes a processor 20 which is arranged to control play of a base game in which various feature events are triggerable. One of the triggerable feature events (hereafter the ‘accumulation feature’) provides players with an opportunity to be awarded feature enhancing elements that can be utilised in at least one other triggerable feature event (hereafter referred to as a ‘modifiable’ or ‘second’ feature event) for providing some form of player advantage therein. For example, the modifiable feature event may have some base prize potential which can be improved by utilising feature enhancing elements awarded to the player in the accumulation feature. Thus, it is of benefit to the player that the triggering of the modifiable feature event be delayed until they have managed to accumulate at least some of the feature enhancing elements that provide the player advantage.

To facilitate the above functionality, the processor 20 implements a number of modules, based on program code stored in memory 13. A display module 22 is operable to provide the display of the wager game implemented by the controller 2. A feature module 24 is arranged to trigger the various feature events either randomly or in response to some predetermined criterion being met (which may be the same trigger or a different trigger for the two feature events, depending on the desired implementation). Random triggers are generated with the aid of a random number generator 26. The feature module 24 is also operable to control play of the feature events including awarding feature enhancing elements during play of the accumulation feature. Importantly, the modifiable feature events may be triggerable by the feature module 24 irrespective of whether the player has accumulated any feature enhancing elements at the time the modifiable feature event is triggered (in which case the modifiable feature event is played at the base prize potential). An award module 28 is operable to apply awarded feature enhancing elements to outcomes of the second feature event for providing the player advantage. The award module 28 is further operable to issue player awards/prizes resulting from play of the wager game.

### Example

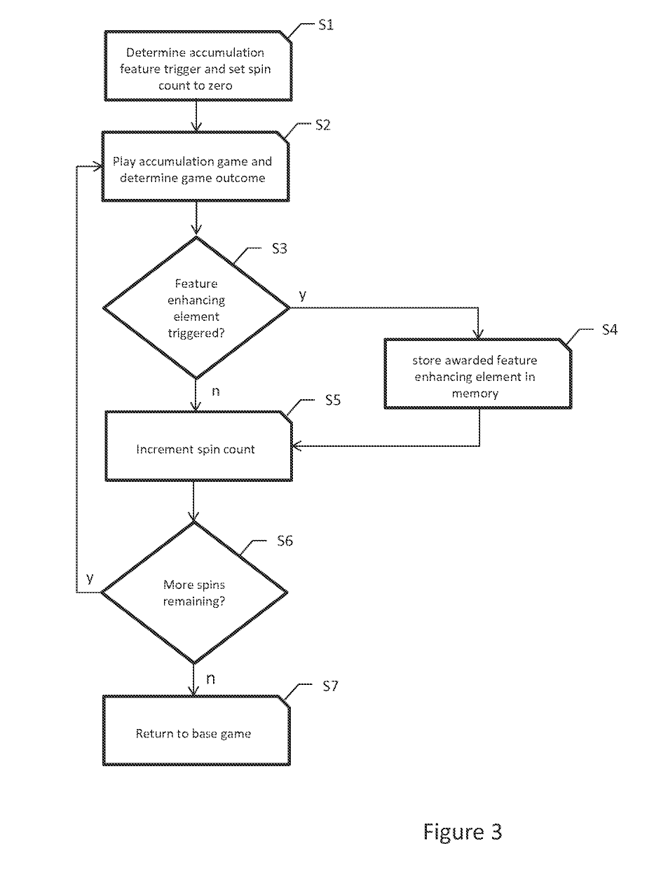

A non-limiting example of an embodiment will now be described with additional reference to the flowcharts of FIGS. 3 & 4. The flowcharts assume that the base game (also commonly referred to as the main game) is in the form of a reel-type game with an accumulation feature that is randomly triggered in response to a particular symbol combination being determined during game play. The accumulation feature also takes the form of a reel-type game, however utilises a different symbol set for determining outcomes than for the base game. According to the example embodiment, the symbol set for the accumulation feature consists of symbols depicting characters and special character abilities. In response to triggering certain symbol combinations, players are awarded corresponding characters and/or special abilities for ‘playing’ in the second feature. For example, in a ‘Dungeons and Dragons’ style feature, a mage character may be awarded in response to three mage symbols appearing on an award payline (e.g. a centre payline). Character abilities (e.g. a fireball, magic staff, etc.) may be awarded in a similar manner. According to the illustrated embodiment the number of spins of the accumulation reel game awarded to the player is determined in dependence on the amount wagered in the base game which triggered the accumulation feature. It will be understood, however, that the number of spins/plays may be determined in independence of the wagered amount (e.g. a fixed or randomly determined number of spins/plays may be awarded), depending on the desired implementation.

According to the illustrated embodiment, the modifiable feature event is randomly triggered during play of the base game in the same manner as the accumulation feature (i.e. in response to a particular symbol combination being determined on a played payline). The second feature event of the example described herein takes the form of a combat game in which awarded characters and their associated abilities can be selected to form a team that will participate in the combat game. A default combat team, for example consisting of a single character with no special abilities, may be playable where the combat game is triggered without the player having accumulated any characters or abilities up to that point. The combat game involves the team progressively fighting various enemies such that the more enemies faced and conquered the greater the prize awarded to the player upon completion of the feature. If the team defeats all of the enemies the player is awarded a major prize, such as a jackpot prize. According to the presently described embodiment, the greater the number of characters/abilities that form the team, the greater the likelihood of the team defeating the various enemies (and thus the greater the prize potential).

FIG. 3 illustrates a process flow upon determining an accumulation feature trigger in a base game outcome. At steps S1 and S2, a spin count for the accumulation feature is set to zero and play of the reel game commences. At step S3 a determination is made as to whether the player is to be awarded a character and/or ability (i.e. by evaluating an outcome of the reel spin, as afore-described). Any awarded characters/abilities are stored in memory 13 (step S4) for use by a player that subsequently triggers the combat game feature. At step S5 the spin count is incremented. If at step S6 it is determined there are more spins remaining, the process returns to step S2. Otherwise, the game ends and the player is returned to the base game (step S7).

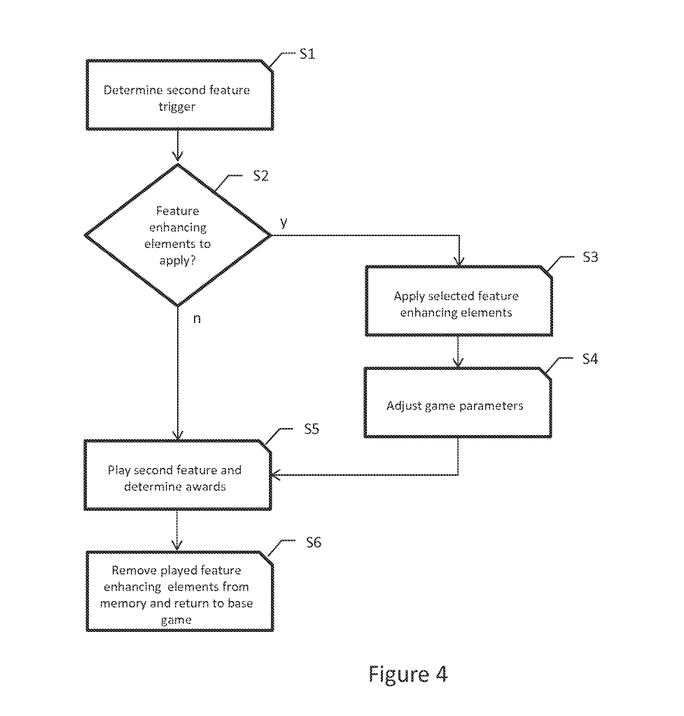

FIG. 4 illustrates a process flow upon determining a combat game feature trigger (i.e. modifiable feature event trigger) in a base game outcome. At step S1 play commences. The feature module 24 subsequently inspects the memory 13 to determine whether the player has been awarded any characters and/or abilities (step S2). If so, the player is then provided an opportunity to add awarded characters and/or abilities to the default team (step S3). Once the team has been formed, at step S4 the feature module 24 adjusts the relevant game play parameters for providing the player advantage in the combat game. If the player has not been awarded any characters/abilities (e.g. the combat game triggered before an accumulation feature was triggered, or the player was not awarded any feature enhancing elements during play of a previous accumulation feature), then steps S3 and S4 are omitted and no adjustments are made to the game play parameters (i.e. the combat game is played using the default team with the default prize parameters). At step S5, an outcome of the combat game is determined and displayed to the player (e.g. 4 out of 7 creatures are defeated resulting in a prize of 180 credits). The characters and abilities played in the game are removed from the memory 13 (step S6) and the player is returned to the base game.

It will be understood that for the example embodiment described above, the awarding of characters and their abilities (or indeed any feature enhancing element operable to provide a player advantage in the modifiable feature event) could be carried out in any suitable manner and should not be seen as being limited to a randomly triggered implementation.

It will also be understood that the various triggerable features may take any suitable form and should not be seen as being limited to the example described above, notwithstanding that feature enhancing elements awarded in the first feature event may be utilised in a subsequently triggered modifiable feature event for providing a player advantage. In a simplified form, the feature events may both be in the form of free spins. For example, a number of free spins (e.g. 5) may be played upon the accumulation feature trigger being determined. In this example, the player is only able to accumulate feature enhancing elements (e.g. multipliers) during play of the free spins. Upon completion of the 5 free spins, a modifiable feature event is played (e.g. a further 10 free spins) during which the player can once again win prizes with the relevant player advantage resulting from any accumulated feature enhancing elements being applied. If no elements are accumulated during the 5 initial spins, the 10 subsequent spins are still played, but without the player advantage (e.g. less likelihood of yielding a prize or a prize of a certain magnitude than if one or more feature enhancing elements had been accumulated).

Other forms of feature event may include, reel re-spins (similar to a free game but with one or more reels held on a slot device), the chance to play for higher winnings (e.g. in a higher-payout game that may require additional wagering), among others. The feature events may be luck or skill based. They may be provided as “second screen” features that are displayed on a separate or remote screen, and may be extraneous to the main game (e.g. with outcomes, triggers and/or game play unrelated to play of the base game).

In an alternative embodiment to that described above, if the modifiable feature event has not triggered within some predefined period of the accumulation feature (e.g. within a set number of spins/plays of the base game, within a set period of time since the accumulation feature was played, etc.), the modifiable feature may be forced to trigger (e.g. using the “Feature Guarantee” triggering technique as described in Australian Patent No 2004281073 entitled “Gaming Apparatus and Systems”, the contents of which are incorporated herein by reference). As yet another alternative, the modifiable feature may be triggered by the feature module 24 immediately upon completion of the accumulation feature (i.e. such that the modifiable feature will always directly follow an accumulation feature).

The feature event triggers may be arranged to occur due to the usual operation of the main game randomly or under a particular set of circumstances, e.g. when a predefined symbol combination occurs after a spin of the reels, a predefined card combination occurring, etc. The triggers may also occur due to an accumulation of circumstances across a number of games, and/or may occur due to the condition of a device supplemental to the EGM 1 itself, e.g. they may relate to jackpot wins in linked jackpot systems comprising a plurality of EGMs under a central control (e.g. the trigger could be set in a manner similar to the way a mystery jackpot is triggered). In a particular embodiment the accumulation feature is triggered in response to the player placing a dedicated accumulation wager. Other such random or manual triggers are within the purview of the skilled person.

In a particular embodiment, the outcomes of the accumulation feature relate solely to the awarding of feature enhancing elements (i.e. no other forms of prize such as credits, free games, jackpots, etc. are awardable during play of the accumulation feature).

In a particular embodiment the modifiable feature comprises a symbol driven game, such as a reel game. The symbol set utilised for randomly determining game outcomes may be modified by utilising feature enhancing elements awarded to the player in the accumulation feature for providing a player advantage. For example, a prize potential for the game may be improved by adding special symbols, such as wild symbols, multiplier symbols, jackpot symbols etc. that were awarded to the player in a previous accumulation feature. In an embodiment, the symbols in the symbol set may be modified by an awarded feature enhancing element, e.g. to increase a value of a multiplier symbol for improving the prize potential. In yet another alternative, the feature enhancing elements may include multipliers that are applied to any credits awarded in the modifiable feature. In a particular embodiment the feature enhancing elements may be selectively utilised by the player, with different feature enhancing elements have different bearings on the player advantage (which may or may not be known to the player, depending on the desired implementation). In a particular embodiment, there may be a limit to the number of feature enhancing elements that may be utilised by the player in the modifiable feature. The limit may, for example, be depending on a wager parameter (e.g. the amount wagered in the game which triggered the modifiable feature).Furthermore, in a particular ‘staged’ form of modified feature game, the player may additionally or alternatively be allowed to select a timing or stage at which to use the awarded feature enhancing elements such that the timing/stage may also have a bearing on the player advantage. For example, using the combat game analogy, different awarded characters may have different fighting abilities such that when matched against a suited enemy those characters have a greater likelihood of defeating the enemy. In this case, players may be allowed to select their combat team for each enemy faced in the multi-stage game, with the particular selection of characters having a direct bearing on the probability of defeating the enemy.

The modifiable feature event may be configured such that certain awarded feature enhancing elements can only be utilised if other predefined feature enhancing elements have been awarded to the player (i.e. certain awardable elements may only provide their associated advantage contingent on other elements having also be accumulated/utilised). For example, again with reference to the combat game example above, the player may only be allowed to select the mage character if they have also been awarded a magic attribute.

It will be understood that the player advantage may take a number of different forms including, but by no means limited to, adjusting the prize potential of the modifiable feature, adjusting a frequency of prize winning outcomes, adjusting the magnitude of prizes on offer in the feature, adding or altering a probability of triggering a special feature such as a jackpot prize, and combinations of the above, among others.

In a particular embodiment the modifiable feature is randomly triggerable within the accumulation feature, irrespective of whether any feature enhancing elements have been accumulated.

In an embodiment, the awarded feature enhancing elements are stored in association with a particular player. For example, the player may be required to insert a player tracking card into the player tracking and marketing means 9 upon commencing game play. Any awarded feature enhancing elements are subsequently stored in a player account maintained by the remote player tracking server (and/or securely on the player card), such that the player can utilised those points in a modifiable feature triggered on that machine or another eligible machine at some later time.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by a person skilled in the art.

1. A method of gaming comprising:
displaying play of a wager game;
triggering a first feature of the wager game in which one or more feature enhancing elements are awardable to a player;
triggering a second feature of the wager game, the second feature being randomly triggerable during play of at least one of the wager game and the first feature; and
allowing awarded feature enhancing elements to be utilised in the second feature to provide a player advantage in the second feature.

2. A method in accordance with claim 1, wherein the first feature comprises a set number of plays such that the feature enhancing elements are randomly awarded to the player during the set number of plays.

3. A method in accordance with claim 2, wherein the first feature is a symbol driven game such that the feature enhancing elements are awarded in response to one or more predefined symbol combinations being triggered during the set number of plays.

4. A method in accordance with claim 1, wherein the awarded feature enhancing elements are selectively utilised by the player, such that not all awarded feature enhancing elements are necessarily utilised in the second feature.

5. A method in accordance with claim 4, further comprising allowing the player to select a time or particular stage in the second feature at which to utilise the feature enhancing elements, such that the selected timing/stage has a bearing on the player advantage.

6. A method in accordance with any one of claim 1, wherein the feature enhancing elements are automatically utilised in the second feature.

7. A method in accordance with claim 1, wherein the second feature comprises a symbol driven game and wherein the feature enhancing elements comprise special symbols that are added to a symbol set from which symbols are randomly drawn for improving a prize potential of the second feature.

8. A method in accordance with claim 1, wherein the second feature comprises a symbol driven game and wherein the feature enhancing elements are operable to modify symbols in a symbol set utilised in the symbol driven game for improving a prize potential of the second feature.

9. A method in accordance with claim 1, wherein the feature enhancing elements are operable to modify an outcome of the second feature for improving the prize potential.

10. A method in accordance with claim 1, wherein the feature enhancing elements are operable to add, modify or improve a probability of triggering, a special feature of the second feature that provides an improved prize potential.

11. A method in accordance with claim 1, wherein the feature enhancing elements can be applied to one or more game play parameters of the second feature.

12. A method in accordance with claim 11, wherein the feature enhancing elements comprise virtual game characters, character abilities and/or objects that can be utilised to progress, or increase a likelihood of progressing through, one or more stages of the second feature for improving the prize potential.

13. A method in accordance with claim 1, wherein different feature enhancing elements are awardable during play of the first feature such that certain awardable feature enhancing elements improve the prize potential more than other awardable feature enhancing elements.

14. A method in accordance with claim 1, wherein play of the first feature does not result in any prizes being awarded to the player other than the feature enhancing elements.

15. A method in accordance with claim 1, wherein the first feature is triggered in response to a wager place by the player.

16. A method in accordance with claim 1, wherein the first feature is randomly triggered during play of the wager game.

17. A method in accordance with claim 1, further comprising allowing certain awarded feature enhancing elements to be utilised in the second feature only if other predefined feature enhancing elements have been awarded to the player.

18. Gaming apparatus comprising:
a display module operable to display play of a wager game;
a feature module operable to trigger a first feature of the wager game in which one or more feature enhancing elements are awardable to a player, the feature module being further operable to randomly trigger a second feature during play of at least one of the wager game and first feature; and
an award module operable to allow feature enhancing elements awarded to the player prior to triggering of the second feature to be utilised in the second feature to provide a player advantage therein.

19. A gaming system comprising:
a gaming terminal implementing a display; and
a gaming controller comprising: a display module operable to display play of a wager game;
a feature module operable to trigger a first feature of the wager game in which one or more feature enhancing elements are awardable to a player, the feature module being further operable to randomly trigger a second feature during play of at least one of the wager game and first feature; and
an award module operable to allow feature enhancing elements awarded in the first feature to be utilised in the second feature to increase a prize potential for the second feature from a base prize potential.

20. A method of gaming comprising the steps of:
displaying play of a wager game;
conducting play of a first feature of the wager game in which one or more feature enhancing elements are randomly awardable to a player;
conducting play of a second feature of the wager game; and
allowing awarded feature enhancing elements to be utilised in the second feature to provide a player advantage in the second feature.

21. A method of gaming comprising the steps of:
displaying play of a game;
triggering a first feature of the game in which one or more feature enhancing elements are randomly awardable to a player; and
triggering a second feature of the game, such that the player is able to utilise awarded feature enhancing elements in the second feature to provide a player advantage therein;
wherein if no feature enhancing elements have been awarded to the player upon the second feature being triggered, the second feature is played without any player advantage.
